(19) United States
(12) Patent Application Publication
(10) Pub. No.: US 2026/0141252 A1
(43) Pub. Date: May 21, 2026

(54) REINFORCEMENT LEARNING WITH TEXT GENERATION & FEEDBACK

(71) Applicant: Philip Osborne, Manchester (GB)

(72) Inventor: Philip Osborne, Manchester (GB)

(21) Appl. No.: 18/955,718

(22) Filed: Nov. 21, 2024

(51) Int. Cl. G06N 3/092

(52) U.S. Cl. CPC G06N 3/092

(57) ABSTRACT

Methods and systems are provided for training an agent to perform actions in an environment using reinforcement learning. A method comprises receiving observation data, generating, based upon the observation data, text data indicating observations of the environment, processing the text data to determine the actions for the agent to perform in the environment, performing, the actions in the environment, determining, based upon an objective function for the agent, a reward value associated with the actions, and updating the policy of the agent based upon the reward value.

### TECHNICAL FIELD

This invention relates to computer-implemented methods for training an agent to perform actions in an environment using reinforcement learning.

### BACKGROUND

In reinforcement learning, an agent may use a policy (e.g. a neural network) to determine actions to take in an environment. The policy of the agent may be trained using a reward value which is determined once an action is performed by the agent in that environment. The reward value indicates to the agent whether a respective action contributes to the agent achieving an objective or goal. Such a reward value is determined based upon an objective function that evaluates the performance of the agent in the environment with respect to the objective or goal. The policy of the agent determines the actions to be performed based upon observations of the environment. Such observations often incorporate a large amount of complex information about the environment for the agent to use to determine appropriate action(s). For example, the observations may be images, video, and/or audio of the environment from the perspective of the agent. There remain, however, challenges associated with training agents in a computationally efficient and effective way. It further remains desirable to train agents to be able to solve multiple problems.

### SUMMARY

According to a first aspect of the invention there is provided a computer-implemented method for training an agent to perform one or more actions in an environment using reinforcement learning. The method comprises receiving observation data indicating one or more observations of the environment in which the agent is configured to perform one or more actions. The method further comprises generating, based upon the observation data, first text data indicating the one or more observations. The method further comprises processing, based upon a policy associated with the agent, the first text data indicating the one or more observations to determine the one or more actions. The method further comprises performing, by the agent, the determined one or more actions in the environment. The method further comprises, in response to the agent performing the determined one or more actions, determining, based upon an objective function for the agent, a reward value associated with the one or more actions. The method further comprises updating the policy of the agent based upon the reward value. The observation data may comprise image data, audio data, video data, numerical data, categorical data, time-series data, geospatial data, and/or sensor data.

By transforming the observation data, e.g. image data, audio data, video data, etc. specifically to the text data, the agent may be trained using a more compressed and efficient representation of the environment, thereby improving performance of the trained agent. Furthermore, the agent may be trained to be applied to multiple different problems and transfer knowledge between problems.

In some implementations, the method further comprises receiving, from a second agent, second text data indicating one or more instructions for the agent. By receiving the second text data indicating instructions for the agent, external input (i.e. the instructions) may be provided. Objective functions in reinforcement learning may be sparse (e.g. they may provide positive feedback relatively infrequently). For example, objective functions may indicate long-term goals rather than evaluating actions on a timestep-by-timestep level. This dynamic may be particularly prevalent when reinforcement learning is used to train agents performing actions in the real world. Thus, in some settings, a large proportion of actions may result in a 0 reward value. Providing instructions for the agent helps guide the agent towards the long-term objective, which may otherwise be computationally inefficient (i.e. require a significant or otherwise suboptimal number of training steps) or impossible to achieve.

The second agent may be a human or a machine learning model. The second text data may be received over a network, such as the internet. For example, the human may input their instructions into a user interface for transmitting them over the network. In another example, the machine learning model (e.g. large language model) may generate the instructions. The instructions may be generated based upon some input, such as text data, image data, etc. indicative of observations of the environment. Likewise, the second text data may be received from the machine learning model over a network (i.e. the machine learning model is connected to the network via any suitable means). The instructions may be text, such as directions, goals, sub-goals, etc. The second text data may be any suitable type of text data such as a vector (e.g. embedding) representing the instructions.

In some implementations, the second agent is a human or a machine learning model, and wherein the policy is a machine learning model.

In some implementations, the method further comprises adjusting the reward value based upon the first text data and the second text data.

In some implementations, adjusting the reward value based upon first text data and the second text data comprises computing a similarity value based upon first text data and the second text data and adjusting the reward value based upon the similarity value. That is, the reward value may be adjusted, e.g. increased, depending upon whether the similarity value (or “confidence measurement”) indicates that the one or more instructions are completed, e.g. if the similarity value exceeds a predetermined threshold.

In some implementations, the method further comprises validating whether the objective function for the agent is maximized, and adjusting the first text data based upon the validation, where the similarity value is computed based upon the adjusted first text data. By adjusting the reward value based upon the first and second text data (i.e. data indicating observations and data indicating instructions), the agent may be directed by following instructions received from the second agent expressed in language. Such direction improves the agent's ability to select appropriate actions in the environment post-training. During training, the observations of the environment (i.e. the first text data) may be adjusted based upon validation feedback, thus further enhancing alignment of the agent as described below.

In some implementations, the method further comprises adjusting the reward value by providing the first text data indicating the one or more observations as input to a first trained machine learning model to output a confidence value indicating whether the agent has completed one or more previous instructions for the agent and adjusting the reward value based upon the confidence value. That is, the confidence value may indicate a confidence that the agent completes a goal (e.g. long-term goal) or sub-goal (e.g. short-term goal). Accordingly, the reward value may be adjusted (e.g. increased) based upon a whether (e.g. a likelihood) the agent satisfies completes a goal or sub-goal.

In some implementations, the first trained machine learning model is trained based upon a training dataset generated by receiving third text data indicating one or more previous observations of the environment, receiving, from the second agent, corresponding ground truth text data indicating the one or more previous instructions for the agent, validating that the objective function for the agent is maximized, and generating the training dataset based upon the third text data and ground truth data. By adjusting the reward value in this way, the trained machine learning model can direct the training of the agent based upon whether the observations predict that the objective function is maximized (e.g. whether a sub-goal has been reached). For example, the training dataset including the ground truth text data and the third text data may have been generated during a previous training session (e.g. the method described below). That is, the third text data may be generated based upon observation data indicating one or more observations of the environment, as described below, and the ground truth text data may be received from a second agent (e.g. a human or machine learning model) indicating one or more instructions for the agent, i.e. as also described below. That is, the first text data may be generated and the second text data received at a first training step, the first and second text data being used as the third text data and ground truth text data respectively. The second agent may then validate that the objective function is maximized. That is, a human (e.g. the second agent) may determine that the current state of the environment, as indicated by the third text data, indicates that the objective function is maximized. For example, if the objective function is a function that evaluates whether the agent has reached a certain score in a game, the objective function may be maximized when the agent reaches that score. In another example, if the objective function evaluates whether the agent has reached one or more sub-goals (e.g. physical locations, or a “score” in a game), the objective function may be maximized if at least one of those sub-goals has been reached. It will be understood that the objective function may be considered maximized if it reaches or is approaching a global or local maxima. That is, the observations of the environment may be analysed, e.g. by the second agent, to determine whether the agent is following instructions received from the second agent. It will be appreciated that whether the objective function for the agent is maximized may be validated in any suitable way (e.g. by the second agent). In response, the training dataset may be generated. For example, the training dataset may only add the third text data and ground truth text data if the objective function for the agent is validated as maximized.

In some implementations, the second text data is generated by the second agent based upon the first text data. By generating the second text data (i.e. instructions) based upon the first text data (i.e. observations), instructions may be formed by taking into account the specific context of the environment. That is, the second agent can tailor its instructions based upon characteristics of the environment as indicated by the first text data. For example, if the environment is a chess game and the first text data represents “A black rook is capable of taking your queen. A white knight is capable of taking the black rook. A black pawn is capable of taking the white knight.”, the second text data may be generated by taking into account such context. In this example, the second text data may be generated to represent “Capture the black rook with the white knight”.

In some implementations, generating the first text data is based upon the second text data. By generating the first text data (i.e. observations) based upon the second text data (i.e. instructions), observations may be formed by taking into account instructions from the agent enhancing or augmenting the observations of the environment received by the first agent.

In some implementations, generating the first text data comprises determining, based upon a predetermined mapping of the observation data to text, first text indicating the one or more observations of the environment and processing the first text with a second trained machine learning model to output the first text data.

In some implementations, the predetermined mapping corresponds to the environment. By generating the first text data in this way, language specific to the environment (i.e. predetermined based on the observation data) may be generated. That is, the first text data may be generated by taking into account domain specific context of the environment by virtue of the predetermined mapping being environment specific. For example, the predetermined mapping may correspond to a chess game environment and may be particularly adapted for generating text representing observations of the chess game environment. The predetermined mapping may be any suitable type of predetermined mapping, such as a machine learning model or a tabular mapping. For example, a machine learning model may be trained (e.g. using supervised training) to generate text representing the observations. Processing the first text may include processing data representing the first text with the second trained machine learning model. Such processing may include providing the data as input to the second trained machine learning model to output the first text data. The second trained machine learning model may be any suitable type of machine learning model, such as a neural network.

According to a second aspect of the invention there is provided a computer-implemented method for controlling an agent in an environment. The method comprises receiving observation data indicating one or more observations of the environment in which the agent is configured to perform one or more actions. The method further comprises generating, based upon the observation data, first text data indicating the one or more observations. The method further comprises processing, based upon a policy associated with the agent, the first text data indicating the one or more observations to determine the one or more actions. The method further comprises performing, by the agent, the determined one or more actions in the environment. For the second aspect of the invention, the agent has been trained according to the method described above with reference to the first aspect of the invention.

There is also described herein a computing system comprising one or more processors and one or more non-transitory computer-readable media storing computer-readable instructions configured to cause one or more processors to perform the method described above with reference to the first and second aspects of the invention.

There is also described herein one or more non-transitory computer-readable media storing computer-readable instructions configured to cause one or more computing devices to perform the method described above with reference to the first and second aspects of the invention.

### BRIEF DESCRIPTION OF THE DRAWINGS

FIG. 1 is a schematic illustration of a reinforcement learning training process.

FIG. 2 is a schematic illustration of a text data generator.

FIG. 3 is a schematic illustration of an adjustment module.

FIG. 4 is a schematic illustration of a training dataset and a trained machine learning model for supervised instruction following.

FIG. 5 is a schematic illustration of an agent being trained using a reinforcement learning training process including instruction following.

FIG. 6A is a first plot of data indicating an average reward value achieved during experimentation.

FIG. 6B is a second plot of data indicating an average reward value achieved during experimentation.

FIG. 7 is a flow diagram of a method for training an agent to perform actions in an environment using reinforcement learning.

FIG. 8A is a flow diagram of a first method for adjusting a reward value.

FIG. 8B is a flow diagram of a second method for adjusting a reward value.

FIG. 9 is a flow diagram of a method for controlling an agent in an environment.

FIG. 10 is a schematic illustration of an exemplary computer system on which aspects described herein may be implemented.

Like reference numbers in the various drawings indicate like elements.

### DETAILED DESCRIPTION

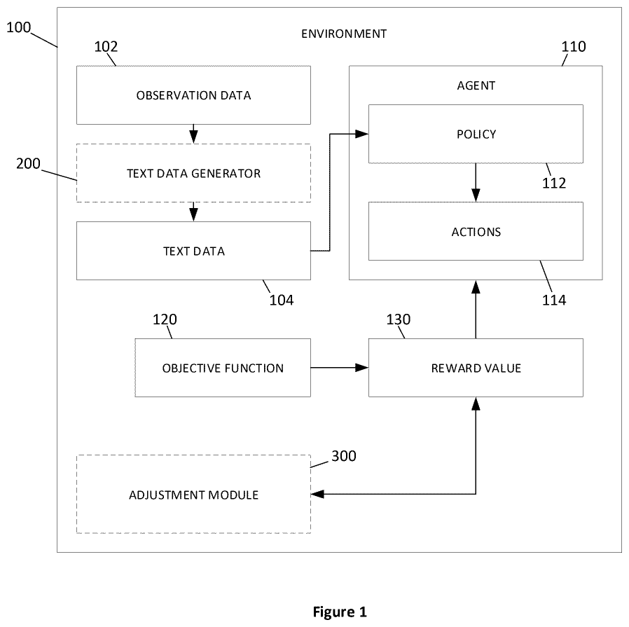

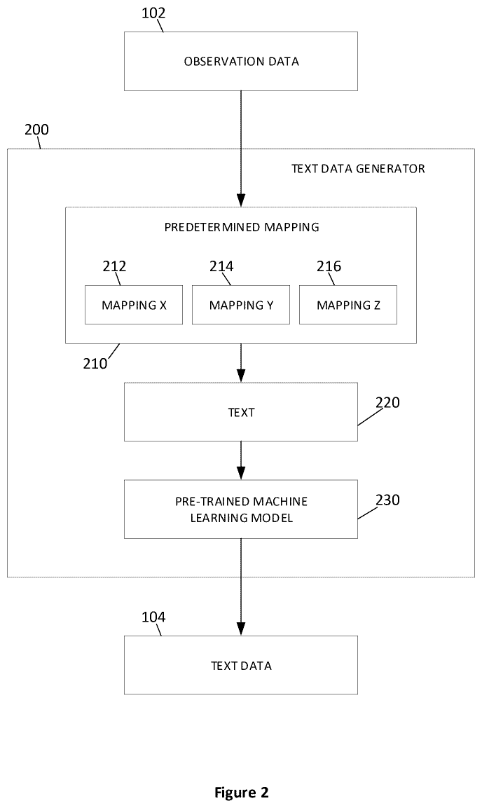

FIG. 1 schematically depicts a reinforcement learning training process. The reinforcement learning training process includes an environment 100 and an agent 110. The process is for training the agent 110 to perform appropriate actions 114 in the environment 100 based upon observations of the environment provided to the agent 110. As will become readily apparent below, to improve the training process, the agent 110 may be trained based upon text data 104 to perform the actions 114, rather than being trained based upon other types of data (e.g. image data). The text data 104 may be generated based upon observation data 102 indicating the one or more observations of the environment 100. The text data 104 may also indicate the one or more observations of the environment 100. To determine the one or more actions 114 for the agent to perform in the environment 100, the agent 110 comprises a policy 112, e.g. a machine learning model. That is, the agent 110 may be configured to perform the actions 114 in the environment 100, the action(s) 114 determined using the policy 112. The policy 112 of the agent may be trained to predict, based upon the text data 104, the appropriate actions 114 to take by taking into account, e.g. the state of, the environment 100 as indicated by the text data 104. For example, if the environment 100 is a chess game environment, the text data 104 may be indicative of the state of the chess board and the actions 114 may be an action which causes a chess piece to be captured. It will be appreciated that the observation data 102 may comprise any suitable data such as image data, audio data, video data, numerical data, categorical data, time-series data, geospatial data, and/or sensor data. That is, the observation data 102 may be received from the environment 100 based upon one or more observed properties of the environment 100. In some embodiments, the observation data 102 does not include text data. Subsequently, the text data 104 may be generated to indicate the observations of the environment 100 in the form of text. The observation data 102 in the form of image, audio, video, etc. is therefore converted to text data. The text data 104 may be generated using a text data generator 200 configured to transform the observation data 102 to the text data 104. Further detail regarding the text data generator 200 is provided with reference to FIG. 2 below.

It will be appreciated that the observation data 102 (e.g. image data, audio data, video data, numerical data, categorical data, time-series data, geospatial data, and/or sensor data) may contain a large amount of noise (i.e. information irrelevant to selecting an action 114). This can impact the ability of the agent 110 to generalise and select appropriate actions 114. By generating the text data 104 (i.e. transforming the observation data 102 to text data 104) based upon the observation data 102, a compressed, efficient, and expressive representation of the environment 100 (i.e. observations of the state of the environment 100) may be produced for training the policy 112 of the agent 110. The agent 110 may therefore be trained more efficiently, by reducing irrelevant information and noise in the observations of the environment 100. As a result, the trained agent 110 is improved (i.e. it is trained to select more suitable actions 114 for the state of the environment 100).

In this manner, for instance, the use of text data—at training time and/or at runtime—as an intermediate representation generated from a prior representation of the observations can provide a number of technical effects and benefits for training machine-learned models and/or for execution of agents that use machine-learned models.

One example benefit may be decreased model size and/or complexity, which may lead to models that require fewer resources to perform an inference operation (e.g., a forward pass through the model). For example, the generation of text data 104 may be implemented using a model (e.g., a learned model or heuristic mapping) that is specifically architected, trained, or otherwise configured for a certain task or set of tasks. The configuration toward a particular task can bias the textual representations of observations (e.g., text data 104) to prioritize data signals that communicate information relevant to a particular task and suppress information not relevant to a particular task. This bias can relieve downstream systems (e.g., agent 110) from processing irrelevant information. By selectively computing an intermediate representation relevant to a task at an upstream stage, then, the downstream systems may be reduced in complexity (e.g., smaller, such as an agent using models having fewer learned parameters or layers) than would otherwise be required if the downstream systems were tasked with processing raw observations directly.

To provide one example, as compared to an alternative approach in which the agent 110 uses a relatively larger multi-modal model to process a large amount of data from different modalities (e.g., potentially including video data which often has extensive data size), in some implementations of the present disclosure, the agent 110 may instead use a relatively smaller text-based model that is configured to process text data (e.g., which often has reduced data size as compared to other modalities such as video data and/or which may have had irrelevant information (noise) removed). Thus, the size of the input to the agent 110 and/or the size of a model implemented by the agent 110 can, in some cases, be reduced, thereby conserving computational resources such as processor cycles, memory consumption etc.

Further, intelligent generation of intermediate representations (e.g., based on task context) can allow for more compact communications between upstream systems (e.g., observation systems, text data generator 200, etc.) and downstream systems (e.g., agent 110). More compact communications can reduce a utilization of communications resources between systems or within a system (e.g., network bandwidth, memory bandwidth and space, etc.). This improvement can facilitate new, efficient architectures that allow for distributed computations across one or more systems or devices. For example, a first system or device can generate text data 104 and communicate the text data 104 to the agent 110 operating on a second system or device. In some implementations, the first system or device can be a more energy efficient or less powerful system or device (e.g., a mobile device or other resource-constrained device). In some implementations, the generation of text data 104 can be implemented using less complex logic (e.g., smaller models or mappings) than used to implement the agent 110. As such, the first device can generate the text data 104 and offload the execution of the comparatively more expensive operations of the agent 110 to another device or system, such as a cloud-hosted device or system. The communications between these devices can be more efficient if implemented via the text data 104 than if implemented by transferring the full raw observations directly. Such improvements can facilitate the use of powerful agents even by relatively inexpensive, low-power edge devices, such as devices on wearables or other mobile devices, robotic platforms, etc.

In this manner, for instance, a technical effect of example implementations of the present disclosure is increased energy efficiency in performing operations using machine-learned models, thereby improving the functioning of computers implementing such models. For instance, example implementations can provide for more energy-efficient runtime execution or inference. In some scenarios, increased energy efficiency can provide for less energy to be used to perform a given task (e.g., less energy expended to maintain the model in memory, less energy expended to perform calculations within the model, etc.). In some scenarios, increased energy efficiency can provide for more task(s) to be completed for a given energy budget (e.g., a larger quantity of tasks, more complex tasks, the same task but with more accuracy or precision, etc.).

Another example technical benefit may be increased sample efficiency during training. For example, a sample efficiency can refer to a progress toward a training objective (e.g., a target performance, an error rate, a reward value, etc.) normalized based on the amount of training samples or data used to achieve the progress. For example, by leveraging highly expressive text data representations of observations (e.g., text data 104) generated using contextual analysis of the raw observations (e.g., using text data generator 200), the training signal that communicates the important information from the environment and any corresponding instructions can be stronger than if raw observation data were received by agent 110 without contextualization or distillation. Training using this expressive signal source can reduce a quantity of updates that either do not shift the policy toward the optimum or shift the policy very weakly to the optimum. For instance, if the training data is “noisy,” the training updates to model parameters may also be “noisy” such that it may take more iterations to converge toward a stable optimum.

Another example technical benefit may be decreased computational cost of processing training data and computing rewards. For example, in some implementations a reward can be based on a similarity between text data representing an observation describing a state of an environment and text data representing a desired state of the environment (e.g., an instruction). For example, text data representing an observation can be represented by a first embedding and text data representing a desired state can be represented by a second embedding. The first embedding and the second embedding can be compared to evaluate how well the current state of the environment aligns with the desired state. These embeddings can be relatively inexpensive to store, retrieve, and compare. For instance, vector operations on embeddings can be highly parallelizable and efficiently computed on hardware accelerators.

In this manner, for instance, example implementations can provide for more energy-efficient training operations or model updates. In some scenarios, increased energy efficiency can provide for less energy to be used to perform a given number of update iterations (e.g., less energy expended to maintain the model in memory, less energy expended to perform calculations within the model, such as computing gradients, backpropagating a loss, etc.). In some scenarios, increased energy efficiency can provide for more update iterations to be completed for a given energy budget (e.g., a larger quantity of iterations, etc.). In some scenarios, greater expressivity afforded by model architectures and training techniques of the present disclosure can provide for a given level of functionality to be obtained in fewer training iterations, thereby expending a smaller energy budget. In some scenarios, greater expressivity afforded by model architectures and training techniques of the present disclosure can provide for an extended level of functionality to be obtained in a given number of training iterations, thereby more efficiently using a given energy budget.

In this manner, for instance, the improved energy efficiency of example implementations of the present disclosure can reduce an amount of pollution or other waste associated with implementing machine-learned models and systems, thereby advancing the field of machine-learning and artificial intelligence as a whole. The amount of pollution can be reduced in to (e.g., an absolute magnitude thereof) or on a normalized basis (e.g., energy per task, per model size, etc.). For example, an amount of CO2 released (e.g., by a power source) in association with training and execution of machine-learned models can be reduced by implementing more energy-efficient training or inference operations. An amount of heat pollution in an environment (e.g., by the processors/storage locations) can be reduced by implementing more energy-efficient training or inference operations.

Furthermore, in many cases it is desirable for the agent 110 to interact with the environment 100 or other agents using natural language. For example, the problem may contain language (i.e. the agent 110 must interpret language or perform actions with language), or external language may need to be integrated as part of the solution, e.g. where human instructions are required (referred to herein as “instruction following”). By transforming the observation data 102 to the text data 104, language may be utilised as part of the solution provided by the agent 110. Additionally, it may be desirable to train the agent 110 to solve multiple problems, such as to be able to solve both games of chess and of checkers. As such, the use of language (i.e. the text data 104) as input to the agent to represent the environment 100, as opposed to any other type of data (i.e. the observation data 102) enables the agent 110, once trained, to be applied to solve multiple problems as well as transfer knowledge between problems.

As such, another example technical benefit may be a more interpretable control surface for understanding and/or guiding actions of the agent. For example, by converting raw observation data (e.g., data 102) into natural language-based textual representations (e.g., text data 104), the inputs to the agent (e.g., agent 110) may be more interpretable. For example, the text data can be reviewed to better understand, in a more directly human-interpretable format, the observations on which the agent is determining its actions (e.g., actions 114). In another example, a user (e.g., a human user) may be enabled to edit the textual representations (e.g., the text data 104) that are provided to the agent (e.g., agent 110). In this case, the behaviour of the agent can be more directly controlled in a human-interpretable manner.

Training the agent 110 may comprise processing the text data 104 indicating the observations of the environment 100 based upon the policy 112 of the agent 110 to determine actions 114. The actions 114 may be one or more available (i.e. possible) actions, also referred to as the agent's 110 “action space”. For example, depending upon the type of agent (e.g. implemented on a computing system controlling actuators to mechanically traverse an environment or manipulate objects in an environment, implemented on a computing system controlling hardware interfaces to electronically alter a state of a computing system, such as by transmitting instructions to software components to execute operations) and the problem that the agent is being trained to solve, the agent 110 may be capable of actuating an end effector (e.g. arm), powering a motor (e.g. to navigate), playing a move in a game (e.g. moving a chess piece), responding to a prompt (e.g. answering a user question), etc. As mentioned, the actions 114 may be determined by processing the text data 104 using the policy 112 of the agent 110. For example, the text data 104 may be an embedding vector representing text indicating observations of the environment. In this example, the embedding vector may be data provided as input to the policy 112. The policy 112 may be a machine learning model such as a neural network, a tabular policy such as a Q-learning model, or any other type of policy 112 suitable for receiving text data indicating observations of the environment 100 and in response outputting data indicating the actions 114, e.g. actions for powering a motor controlling a robot. It will be appreciated that the data indicating the actions 114 (i.e. the output from the policy 112) may be output in any suitable form, such as a vector representing the one or more actions 114. For example, actions 114 may comprise discrete and/or continuous values, e.g. [0, 1, 1, 1, 0, 0] or [0.566, −0.122, 0.443, 0.967, −0.113] each indicating a different action. That is, the action space may be singular or multi-dimensional, and the data indicating the actions 114 may be discrete or continuous. It will appreciate that the actions 114 may depend upon the particular agent 110 and its particular problem. For example, a robotic arm may require a multi-dimensional action space for precisely controlling a plurality of motors with continuous actions (e.g. rotate 0.456 of a full turn of a first motor), whereas an agent controlling a trading strategy may only require a single action per training step (e.g. to buy, hold, or sell) which may be indicated by a discrete value (e.g. 1, 0, −1). It will be understood that for the agent 110 to perform the actions 114, the data indicating the actions 114 (i.e. data received from the policy 112) may be configured to cause the actions 114 to be executed upon being processed by the agent 110.

Training the agent 110 may further comprise performing, by the agent 110, the actions 114 in the environment 100. In response to the agent 110 performing the actions 114 in the environment 100, a reward value 130 associated with the actions 114 may be determined. The reward value 130 may be determined based upon an objective function 120 for the agent 110. The objective function 120 may be any function that evaluates a performance of the agent 110 in the environment 100. For example, the agent 110 may be faced with the problem of maximising a score in a particular game and the objective function 120 could be a linear function that outputs a higher reward value 130 for higher scores in that game. In some examples, the objective function 120 may determine a low reward value 130 if the actions 114 cause the agent 110 to make negative progress towards its goal, and a high reward value 130 if the actions 114 cause the agent to make positive progress towards its goal. That is, for a particular training step, the objective function 120 may evaluate whether the agent 110 has made progress toward its goal with respect to a previous training step. The objective function 120 may be considered maximized if the reward value 130 is approaching either a local or global maxima. That is, for the objective function 120 to be considered “maximized” it is not necessary for the reward value 130 to reach the highest possible reward for that environment 100. For example, the objective function 120 may be considered maximized if a goal or a sub-goal for the agent 110 has been reached, or simply that the agent 110 is making progress to that goal or sub-goal. In implementations, the reward value 130 may be a value between 0 and 1, but it will be appreciated that the reward value 130 may be in any suitable form (i.e. suitable for being used to train, or update, the policy 112 of the agent 110). Training the agent 110 may further comprise updating the policy 112 based upon the reward value 130. For example, if the policy 112 is a neural network, the reward value 130 may be used as a loss value for the neural network. It will be readily appreciated that the policy 112 of the agent 110 may be updated in any suitable way using the reward value 130.

Updating the policy 112 can include training a machine-learned model that implements the policy 112. Training a machine-learned model can include computing a gradient with respect to a loss value (e.g., a reward, such as the reward value 130) at a particular parameter location of the machine-learned model and updating a value of the corresponding parameter to optimize the value of the loss value (e.g., decrease a loss, increase a reward). The loss or reward can be backpropagated through one or more portions of the machine-learned model for computing the gradient. The updated value(s) can be stored in memory. The updated value(s) can be retrieved from the memory to perform inference at runtime or in future training iterations.

Once the agent 110 has been trained according to this process, which may occur over multiple (e.g. thousands) of iterations, the agent 110 may be referred to as “trained”. The trained agent 110 may then be applied to a “live” environment such as the environment 100 used during training (or an environment having one or more properties corresponding to the training environment) - referred to herein as “inference”. That is, the agent 110 may be controlled in the live environment according to its trained policy 112. The trained agent 110 may receive e.g. from the live environment, observation data indicating one or more observations of the live environment in which the agent is configured to perform one or more actions. Subsequently, text data indicating the one or more observations of the live environment may be generated based upon that observation data. The text data indicating the one or more observations of the live environment may then be processed using the trained policy 112 to determine the one or more actions for the live environment. Finally, the trained agent 110 may perform the determined one or more actions in the live environment. Like before, this process happens iteratively while the trained agent 110 is acting in the live environment.

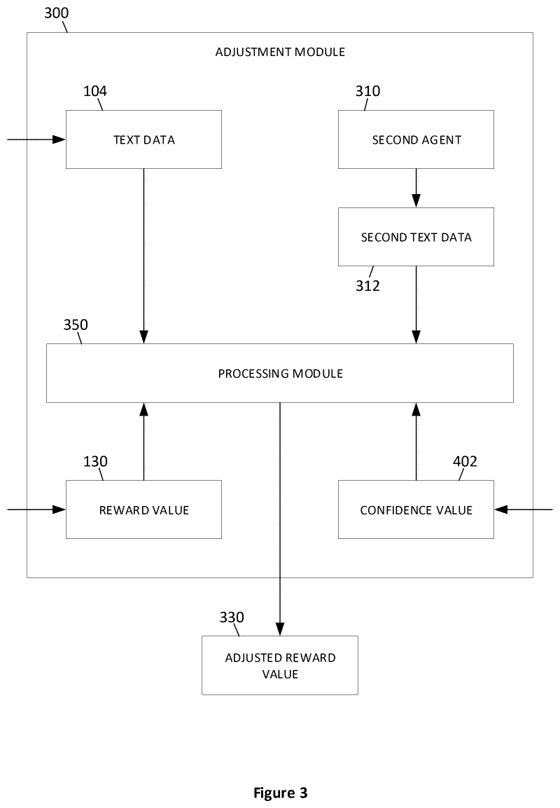

As will become readily apparent with reference to FIG. 3 below, the reward value 130 may be adjusted by an adjustment module 300 prior to being used to update the policy 112 of the agent 110. Further detail regarding the adjustment module 300 is provided with reference to FIG. 3 below. For the purposes of illustration, the text data generator 200 and adjustment module 300 are depicted as part of the environment 100. It will be readily appreciated that the text data generator 200 and the adjustment module 300 need not be part of the environment 100. In general, the environment 100 may be either a real or simulated environment. For example, the environment 100 could be a chess game environment (i.e. simulated on a computer) or a physical obstacle course for a robot. Likewise, the agent 110 may be either a real or simulated agent. For example, the agent 110 could be a player entity of the chess game (i.e. a player entity controlling the white or black pieces) or a robot for navigating the obstacle course. In a first experiment, the agent 110 was trained to control a sailboat in a simulation. In a second experiment, the agent 110 was trained to control a player entity in a game of chess. It will be appreciated that the reinforcement learning training method described herein may be applied to any suitable reinforcement learning problem such as robotics (e.g. autonomous navigation, robotic manipulation where the agent 110 is a robot), mechanical control systems where the agent 110 controls, e.g. manufacturing control systems or quality assurance, medical imaging where the agent 110 is trained to classify medical images, energy control systems such as smart grids or power plant control, natural language processing tasks where the agent 110 may be trained to output natural language in response to a prompt, multi-agent systems including multi-agent collaboration, etc.

It will be understood that the reinforcement learning process schematically illustrated in FIG. 1 may be applied to a range of problems. In one example, the environment 100 may be a chess game environment and the agent 110 may be an entity controlling the white pieces in that game. The observation data 102 may be indicative of observations of the chess game, such as data indicative of a state of a chess board such as an array of values (see the description of FIG. 2 below). As described above and as will become readily apparent with reference to FIG. 2, the text data 104 may be generated based upon that observation data 102, i.e. the observations of the chess board. Accordingly, the text data 104 may indicate the observations of the environment 100 as “The black player has a rook capable of capturing your queen”. The agent 110 may process the text data 104 based upon the policy 112 to determine the actions 114, e.g. an action for the agent 110 that causes the agent 110 to capture the rook. As will be appreciated, the action space for the agent 110 in this specific example may include all possible moves for the white player in their position of the chess game. Once the agent 110 has performed those actions 114 in the chess game environment, the reward value 130 may be determined based upon the objective function 120. For example, the reward value 130 may be a high value if the actions 114 cause the agent 110 to capture the opposing player's rook, but may be a low value if the agent 110 selects an action that negatively affects the agent's 110 likelihood of success, such as predisposing the white player to checkmate. The objective function 120, in this example, could be any function that evaluates the performance of the agent 110 acting as the white player. For example, the objective function 120 could be a simple linear function that generates an increasing reward value 130 for an increasing score in the game of chess, such as a score of 8 indicating that the white player has captured 2 pawns (i.e. a score of +1 for each), 1 knight (i.e. a score of +3 for each), and 1 bishop (i.e. a score of +3 for each). In another example, the score could be generated by any known chess engine indicative of the performance of the agent 110 in the game and used by the objective function 120 to determine the reward value 130. As previously described, the policy 112 of the agent 110 may then be updated accordingly based upon the reward value 130, thereby training the agent 110 to generate appropriate actions 114 for the current state of the chess game (i.e. to reinforce the agent 110 to select the actions 114 that maximize the score in that game for a specific state of the chess board).

FIG. 2 schematically illustrates the text data generator 200 for generating (i.e. outputting) text data 104 of FIG. 1. The text data generator 200 may be configured to output the text data 104 based upon the observation data 102, e.g. by receiving the observation data 102 as input and outputting the text data 104. The text data generator 200 may correspond to the environment 100. That is, the text data generator 200 may be specifically adapted for the environment 100, and there may be a different text data generator 200 for each possible environment 100. For example, the text data generator 200 may correspond to a chess game environment, whereas a different text data generator may correspond to a robot obstacle course environment. In this way, appropriate text data 104 may be generated by taking into account the specific context of the environment 100. The text data generator 200 may comprise a predetermined mapping 210 of observation data (e.g. the observation data 102) to text 220. That is, the predetermined mapping 210 may take the observation data 102, e.g. image data, as input and in response output the text 220. In some examples, the predetermined mapping 210 is a machine learning model such as a neural network. In other examples, the predetermined mapping 210 is tabular data or data such as a hashmap. The predetermined mapping 210 may be any suitable mapping between the observation data 102 and the text 220.

The predetermined mapping 210 may comprise mapping X 212, mapping Y 214, and mapping Z 216. For example, where the agent is configured to control a chess game, the observation data 102 may be a numerical representation of the state of the chess game, where a different number indicates a different piece, and where positive numbers represent white pieces whereas negative numbers represent black pieces:
Row 7: [−4, −2, −3, −5, −6, −3, −2, −4]
Row 6: [−1, −1, 0, 0, −1, −1, −1, −1]
Row 5: [0, 0, −1, 0, 0, 0, 0, 0]
Row 4: [0, 0, 0, −1, 0, 0, 0, 0]
Row 3: [0, 0, 0, 0, 1, 0, 0, 0]
Row 2: [0, 0, 0, 0, 0, 2, 0, 0]
Row 1: [1, 1, 1, 1, 0, 1, 1, 1]
Row 0: [4, 2, 3, 5, 6, 3, 0, 4]
   In this example, mapping X 212 may map numerical values in rows 4, 5, and 6 of the observation data 102 (i.e. [[−1, 0, 0], [0, −1, 0], [0, 0, −1]]) to text of “Black defends with the Caro-Kann Defence”. The text of “Black defends with the Caro-Kann Defence” may then be used as the text 220. Mapping Y 214 and mapping Z 216 may also be used to output the text 220. For example, mapping Y 214 may map the numeric values of the observation data 102 to text of “No captured pieces”, e.g. based upon a determination that a sum of all of the values equals zero. In this example, both mapping X 212 and mapping Y 214 may be used and the text 220 may be a concatenation of “Black defends with the Caro-Kann Defence” and “No captured pieces”. It will be readily appreciated that any number of mappings may be used for the predetermined mapping 210. In this way, the predetermined mapping 210 outputs the text 220 which encapsulates information about the environment, i.e. from the observation data 102, in an efficient and useful manner.

The text data generator 200 may further comprise a pre-trained machine learning model 230. The pre-trained machine learning model 230 may have been previously trained to output the text data 104 in response to receiving the text 220 as input. The pre-trained machine learning model 230 may be an embedding model, e.g. a Transformer-based neural network, that is configured to generate an embedding (i.e. latent vector representation) of the text 220, where the embedding is the text data 104. For example, the pre-trained machine learning model may be a word2vec model. In this example, the word2vec model may receive the text “Black defends with the Caro-Kann Defence” as input and output a representation of that text, e.g. [−0.284, 0.576, −0.710, 0.121, −0.592, 0.345, −0.163, . . . ], as the text data 104. It will be appreciated that the pre-trained machine learning model 230 may be any suitable type of machine learning model for generating the text data 104 based upon the text 220. It will also be appreciated that the pre-trained machine learning model 230 may receive input tokens representing the text 220 as input, rather than the text 220 itself. Once the text data 104 is output by the text data generator 200, the text data 104 may be provided as input to the policy 112 of the agent 110 during training (or inference), as previously described.

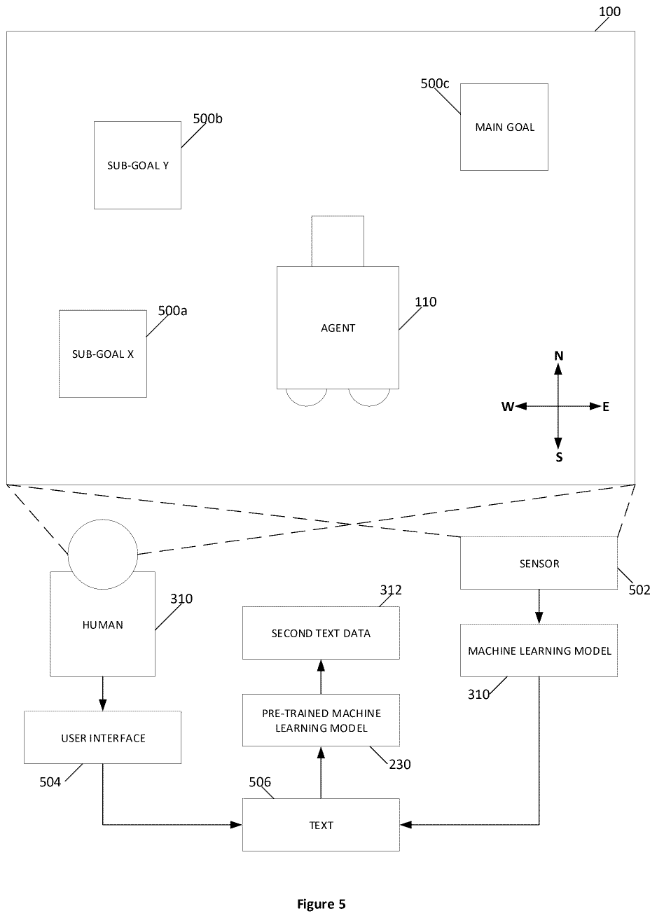

FIG. 3 is a schematic illustration of an adjustment module for adjusting the reward value 130. That is, the reward value 130 used to train the agent 110 may be adjusted (i.e. adjusted reward value 330) to direct training of the agent 110. With reference to FIG. 1, training the agent 110 may further comprise receiving second text data 312 from a second agent 310. For example, the second agent 310 may provide instructions such as “Navigate to sub-goal 13”. In another example, the second agent 310 may provide instructions such as “Take the knight on e4”. As will become readily apparent with reference to FIG. 5 below, the second text data 312 received from the second agent 310 may be a result of processing text received from the second agent 310 with the same pre-trained machine learning model 230 from FIG. 2. It will also become readily apparent that the second agent 310 may be a human or a machine learning model. In some examples, the second text data 312 may be generated by the second agent 310 based upon the text data 104. That is, the second agent 310 may receive the text data 104 prior to generating the second text data 312. For example, if the second agent 310 is a human, the human may view the text data 104 (e.g. on a display representing the text “You are arriving at sub-goal 13”) prior to generating the instruction(s). In another example, if the second agent 310 is a machine learning model, the machine learning model may receive the text data 104 as input prior to generating the second text data 312. In this way, the instructions of the second agent 310 may take into account the current observation(s) of the environment 100. In other examples, the text data 104 is generated based upon the received second text data 312. That is, the observations of the environment may include the instructions provided by the second agent 310. For example, the instruction “Navigate to sub-goal 13” may be received from the second agent 310 prior to generating the text data 104. In this example, the instruction “Navigate to sub-goal 13” may be concatenated with other text representing the observations of the environment 100, and be encoded as part of the text data 104 indicating observations of the environment as previously discussed. For illustration purposes, the adjustment module 300 comprises the second agent 310, however it will be appreciated that the second agent 310 does not need to be a part of the adjustment module 300.

Adjusting the reward value 130 (i.e. to output the adjusted reward value 330) may be based upon the text data 104 and the second text data 312. For example, a processing module 350 (i.e. one or more processors) may compare the text data 104 and the second text data 312 to adjust the reward value 130—referred to herein as an “unsupervised instruction following process”. In some examples, adjusting the reward value 130 based upon the text data 104 and the second text data 312 may comprise computing a similarity value. The similarity value may comprise a cosine similarity value, a Euclidean similarity value, a Manhattan similarity value, a Jaccard similarity value, and/or any other suitable similarity value. For example, the similarity value may be a value between 0 and 1 indicating a similarity between the text data 104 and the second text data 312, where a higher value indicates a higher similarity. That is, the text data 104 may be a vector representing the one or more observations of the environment 100, and the second text data 312 may be a vector representing the one or more instructions. For example, the text data 104 may be [0.121, −0.613, 0.899, −0.211, . . . ] representing the instructions “You are arriving at sub-goal 13”, and the second text data 312 may be [0.126, −0.679, 0.989, −0.234, . . . ] representing the instructions “Navigate to sub-goal 13”. Accordingly, the processing module 350 may compute a similarity value using these vectors. In some examples, adjusting the reward value 130 may include determining whether the similarity value exceeds a predetermined threshold. If the threshold is exceeded, the objective function 120 for the agent 110 may, in some examples, be considered maximized (or, as explained below, this may indicate that the instruction indicated by the second text data 312 has been completed). In response, the reward value 130 may be adjusted in any suitable way, such as by increasing the reward value 130 by a predetermined amount, i.e. to take into account that the objective function 120 for the agent 110 is considered maximized. For example, the reward value 130 may be increased by a value corresponding to the instruction indicated by the second agent 310 to reward the agent 110 for maximizing its objective function 120 and reinforce the selected actions 114. It will be appreciated that adjusting the reward value 130 may be accomplished in any suitable way.

In some implementations, unsupervised instruction following may be enhanced in the following way to further align the agent 110. “Aligning” as used herein refers to training the agent 110 such that the agent 110 performs actions 114 which are in accordance with an intent of the instruction(s) provided by the second agent 310. To this end, the second agent 310 may validate that the text data 104 indicating the observations of the environment complete the second text data 312 indicating the instructions for the agent 110, thereby validating that the objective function 120 is maximized (as previously described above). For example, the validation may be a binary signal received from the second agent 310 where 1 indicates that the instruction is complete and 0 indicates that the instruction is not complete. An instruction may be considered complete if the agent 110 is considered, e.g. by the second agent 310, to have followed the second agent's 310 instructions. For example, this could include performing actions as indicated by the instructions. In another example, this could include the agent 110 achieving a goal indicated by the instructions. In such a way, the second agent 310 may validate that particular observations of the environment 100 indicate that the instruction(s) for the agent 110 have been carried out in accordance with an intent of the instructions.

In response to the validation, the text data 104 may be adjusted. That is, the text data 104 indicating observations of the environment 100 may be adjusted to align the agent 110 by adapting the observations (i.e. a perception of the agent 110) of the environment 100 based upon feedback from the second agent 310. As previously described, the text data 104 and the second text data 312 may both be vectors, referred to below as first vector and second vector respectively. In some implementations, the first vector is adjusted such that the first vector converges or diverges from the second vector, subject to the validation (e.g. a binary signal). For example, a binary signal of 1 indicating that the instruction has been completed may cause the first vector to converge to the second vector, whereas a binary signal of 0 indicating that the instruction has not been completed may cause the first vector to diverge from the second vector. In this way, the second agent 310 may provide feedback in the form of validations, as previously described, to augment the text data 104 indicating observations of the environment. Accordingly, the adjusted text data 104 may be used to affect the similarity score. The adjustment may be performed in any suitable way such as using a feedback vector comprising one or more adjustment values each for adjusting a corresponding value of the text data 104. In this case, the adjustment may be performed by multiplying (e.g. dot product) the first vector with the feedback vector.

Once the text data 104 has been adjusted, a similarity value may be computed as before (i.e. based upon the adjusted text data 104 and the second text data 312). It will be appreciated that, by adjusting the text data 104 based upon the validation, as previously described, the similarity value computed using the adjusted text data 104 may be affected. In other words, the similarity value may increase in response to a validation that the objective function 120 for the agent is maximized, whereas the similarity value may decrease in response to a validation that the objective function 120 for the agent is not maximized. This may be a result of the increased convergence or divergence of the first vector (i.e. text data 104) to the second vector (i.e. second text data 312). Hence, the adjustment to the reward value 130 (e.g. by thresholding as above) may also be affected because the similarity value may increase or decrease. In this way, the reward value 130 may be adjusted by taking into account validation feedback from e.g. the second agent 310 received during training. This process may occur over numerous steps of training to improve alignment of the agent 110.

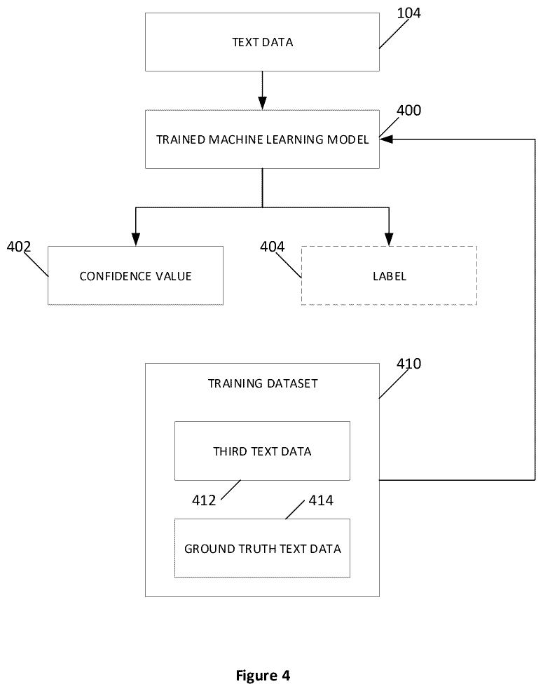

FIG. 4 schematically depicts a training dataset 410 and a trained machine learning model 400 trained according to the training dataset 410. The training dataset 410 may be generated during an initial training stage for the agent 110 (e.g. during unsupervised instruction following as described above) and may be used during further training stages (i.e. during a supervised instruction following training phase, as described below) to enhance and further align the agent 110 without requiring further instructions from the second agent 310. As will become readily apparent, the trained machine learning model 400 may be provided as a mechanism for predicting whether particular observations of the environment 100 indicate that an instruction has been completed. The reward value 130, as above, may be adjusted using the output of the trained machine learning model 400 to align the agent 110 during training. That is, to further enhance the adjustment process (i.e. adjusting the reward value 130), a “supervised instruction following process” is provided.

To generate the training dataset 410, during initial training, the second agent 310 may validate that the text data 104 indicating the observations of the environment complete the second text data 312 indicating the instructions for the agent 110 (as previously described with reference to unsupervised instruction following). Accordingly, a training dataset 410 comprising pairs of the text data 104 and the second text data 312 may be generated. The pairs may be stored and used to train a machine learning model for adjusting the reward value 130. It will be appreciated however that the training dataset 410 may be obtained by any suitable means, such as from external sources or as a result of processing/extracting data from existing training datasets, rather than being specifically generated during the initial training phase.

The text data 104, as part of the training dataset 410, is referred to herein as third text data 412. The second text data 312, as part of the training dataset 410, is referred to herein as ground truth text data 414. In an example, the training dataset 410 may be generated if the second agent 310 determines that the observations of the environment 100 indicate that the instructions received from the second agent 310 have been fulfilled or completed, thereby validating that the objective function 120 is maximized (as previously described above). That is, the pair of the third text data 412 and the ground truth text data 414 in the training dataset 410 may represent one or more “previous” observations and “previous” instructions respectively, i.e. previously generated/received text data 104 and second text data 312. For example, if the text data 104 represents “You are at sub-goal 13” and the second text data 312 represents “Navigate to sub-goal 13”, this pair may be validated, e.g. by the second agent 310, to confirm that the objective function 120 for the agent 110 is maximized, and generate the training dataset 410 accordingly, i.e. by adding the text data 104 (i.e. observations) and the second text data 312 (i.e. instructions) to the training dataset 410. In another example, if the text data 104 represents “You are far away from sub-goal 9” and the second text data 312 represents “Navigate to sub-goal 9”, this may indicate that the objective function for the agent is not maximized, and therefore the pair (i.e. the text data 104 and the second text data 312) may not be validated and therefore not be used to generate the training dataset 410, i.e. not added as the third text data 412 and the ground truth text data 414 respectively. This process may happen multiple times over multiple training steps for multiple different pairs of “previous” observations and instructions in order to generate the training dataset 410. As a result, the training dataset 410 comprises pairs of validated text data indicating previous observations and instructions that were previously validated as e.g. completed.

A machine learning model 400 may be trained using the training dataset 410 in any suitable way (e.g. supervised training). The trained machine learning model 400 may be any suitable machine learning model, such as a neural network. The trained machine learning model 400 may be configured, i.e. as a result of its training, to receive as input the text data 104 (i.e. the text data 104 at a later stage after the training as described above) and in response output a confidence value 402 indicating whether the agent 110 completes one or more previous instructions (i.e. instructions received during a previous training stage) for the agent 110. For example, the trained machine learning model 400 may be trained to output a label 404 corresponding to a previously received instruction, i.e. indicated by the ground truth text data 414 of the training dataset 410. That is, the confidence value 402 may indicate a confidence that the predicted label 404 corresponds to previously received instruction(s). For example, a previously received instruction may be “Navigate to sub-goal 13” and the current observations may be “You are arriving at sub-goal 13”. In this example, the confidence value 402 may indicate a high confidence. The confidence value 402 may be any suitable value, such as a probability. For example, the confidence value 402 may be 0.98 indicating a high probability that the observations of the text data 104 correspond to the previously received instruction of “Navigate to sub-goal 13”, the label 404 corresponding to the instruction. That is, the confidence value 402 may indicate a confidence that, for some observation(s) of the environment 100, previously received instruction(s) are completed, i.e. by the agent 110. It may be therefore inferred from the confidence value 402 that the objective function 120 for the agent 110 is being maximized (i.e. reaching a global or local maxima), because the observations(s) of the environment 100 indicate that the agent 110 has likely completed a previous instruction. In another example, if the text data 104 is “You are close to sub-goal 9”, and no instructions were previously received in relation to sub-goal 9, meaning that the trained machine learning model 400 has not been trained on such data, the confidence value 402 for the text data 104 indicating those observations may be a low value, e.g. 0.07. In this example, a low probability may indicate that the agent 110 is unlikely to have completed any previously received instructions. Accordingly, with reference to FIG. 3, the processing module 350 may then adjust the reward value 130 based upon the confidence value 402. For example, if the confidence value 402 is above a certain threshold (e.g. 0.95), this may indicate that there is a high likelihood that the agent 110 has completed a previous instruction (i.e. that the objective function 120 for the agent 110 is maximized). To account for this, the reward value 130 may be increased in any suitable way, e.g. by multiplying the reward value 130 by a positive integer, to reward the agent 110 for selecting action(s) 114 that previously competed one or more of the second agent's 310 instruction(s). In another example, if the confidence value 402 is below a certain threshold (e.g. 0.5), the reward value 130 may not be increased, or could be decreased depending upon the implementation. It will be readily understood that adjusting the reward value 130 based upon the confidence value 402 may be achieved in any suitable way to reinforce the previously described instruction following process. The adjusted reward value 330 may then be used as the reward value 130 for training the agent 110, as previously described.

FIG. 5 schematically illustrates the agent 110 being trained using a reinforcement learning training process including instruction following, as previously described. The second agent 310 may be configured to observe the environment 100 (i.e. indicated by the dotted lines, and including observations of the agent 110) and in response output text 506. As described above with reference to FIG. 3, the second agent 310 may be a human. In such an embodiment, the second agent 310 may observe the environment 100 in any natural way, and the text 506 may be received from the human 310 via a user interface 504.

As described above with reference to FIG. 3, the second agent 310 may be a machine learning model. In such an embodiment, the machine learning model may be configured to receive observations of the environment 100 as input in any suitable way, e.g. image data representing the environment 100 being received via a sensor 502 (e.g. camera). In response to this input, the machine learning model 310, which may be a visual language model (VLM) for example, may output the text 506.

A pre-trained machine learning model 230 (i.e. the same pre-trained machine learning model for generating the text data 104 as previously described with reference to FIG. 2) may be used to generate the second text data 312, e.g. such that the text data 104 and the second text data 312 may be effectively compared in a common embedding space. In some examples, the pre-trained machine learning model 230 may form part of the second agent 310 if the second agent 310 is a machine learning model. In this way, the text data 104 and the second text data 312 may be effectively compared (i.e. using supervised and/or unsupervised instruction following as described above). That is, the adjustment module 300 may receive the second text data 312 from the second agent 310 over a network for adjusting the reward value 130, i.e. to provide the instruction following.

During training of the agent 110 (e.g. in FIG. 5, a robot), in a first step of a first episode, the observation data 102 is received. For example, the observation data 102 may be image data representing a visual perception of the agent 110 in the environment 100, the visual perception including a perception of a sub-goal X 500a, a sub-goal Y 500b, and a main goal 500c. The image data may be data representing an array of pixel values, for example. In response, the text data 104 may be generated based upon that observation data 102. For example, the text data generator 200 may be configured to receive the image data and output the text 220 using the predetermined mapping 210, in this example a predetermined mapping between image data and text. For example, mapping X 212, mapping Y 214, and mapping Z 216 may each map certain patterns in the image data to certain text, such as “You are located east of sub-goal X”, “You are located south-east of sub-goal Y”, and “You are located south-west of main goal” respectively. Once the text data 104 is generated, e.g. data representing “You are located east of sub-goal X; You are located south-east of sub-goal Y; You are located south-west of main goal”, the text data 104 may be processed based upon the policy 112 associated with the agent 110 to determine the action(s) 114 for the agent 110. The action(s) 114 may be for the agent 110 to power particular motor(s) controlling the agent 110, i.e. the robot, to navigate north-east towards the main goal 500c. In the same step of training, once the action(s) 114 are performed, the reward value 130 may be determined based upon the objective function 120. In this example, the objective function 120 may be a function which evaluates that the robot is correctly navigating to one of its objectives (i.e. the main goal 500c), such as a measure of distance between the physical location of the agent 110 and the main goal 500c. It will be understood that the objective function 120 in this example could be more complicated, for example by taking into account its relative position of the agent 110 between each of the sub-goals 500a 500b and its location history (i.e. whether it has visited any of the sub-goals 500a 500b). In this example, if the agent 110 is navigating (i.e. making progress) to the main goal 500c, the reward value 130 may be determined to be relatively high, e.g. 0.6. Once the reward value 130 has been determined, the policy 112 of the agent 110 may be updated based upon that reward value 130. In this example, the reward value 130 may be used to train the agent 110 such that the agent 110 learns that the particular action(s) 114 that caused the agent 110 to navigate north-east to the main goal 500c are “positive” actions 114 to take in light of the particular state of the environment, i.e. as indicated by the text data 104 as “You are located east of sub-goal X; You are located south-east of sub-goal Y; You are located south-west of main goal”. The processes described above may be repeated over a plurality of steps (i.e. a complete cycle of the process described above), and a plurality of episodes (i.e. a complete cycle of the agent 110 acting in the environment until the agent 110 reaches a terminal state, such as reaching the main goal 500c).

Prior to updating the policy 112 of the agent 110, the reward value 130 may be adjusted (e.g. as previously described) based upon the second text data 312. For example, the second text data 312 may indicate “Navigate west to sub-goal X; Do not navigate north”. That is, the second agent 310 may instruct the agent 110 to navigate particularly to sub-goal X 500a. The reward value 130 may then be adjusted accordingly based upon the text data 104 and the second text data 312, for example by computing a similarity value as previously described, i.e. unsupervised instruction following. Alternatively, or in addition, the reward value may be adjusted according to the supervised instruction following described herein with reference to FIG. 4. In both cases, the observations as indicated by the text data 104 may be evaluated to determine whether they complete the instructions received from the second agent 310 indicated by the second text data 312. For example, highly similar observations and instructions, such as “You are navigating west to sub-goal X” and “Navigate west to sub-goal X” respectively indicate that the instruction(s) have been completed, and hence that the objective function 120 for the agent 110 is maximized. As a result, adjusting the reward value 130 to further reinforce these actions 114 and follow those instruction(s) is desirable. In another example, if the observation “You are navigating west to sub-goal X” has previously been validated as completing an instruction, e.g. “Navigate west to sub-goal X”, this may also indicate that such actions 114 should be reinforced. By representing the observations of the environment 100 as text, the agent 110 may be trained to follow instructions received from the second agent 310 for solving the problem depicted in FIG. 5 of controlling the agent 110, i.e. robot.

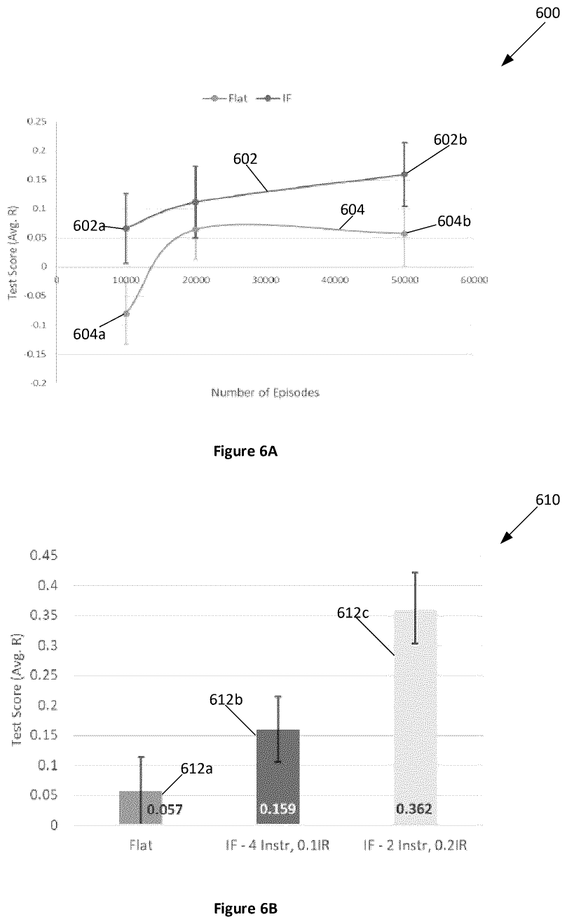

FIG. 6A depicts a first plot 600 of data generated during experimentation with the reinforcement learning training processes described herein. The plot 600 comprises a first plot 602 of data indicating an average reward value by a number of training episodes. A training episode may be understood as a single cycle through the environment 100 where the agent 110 reaches a terminal state (e.g. reaches a goal or sub-goal that maximizes the objective function of the agent 110). The first plot 602 corresponds to the reinforcement learning training process described herein including instruction following (e.g. adjusting the reward value based upon received instructions - “instruction following”). The plot 600 of data further comprises a second plot 604 of data indicating an average reward value by a number of training episodes for a baseline (i.e. standard) reinforcement learning training process (i.e. “baseline”). That is, the baseline process utilised no instruction following and did not represent the observations of the environment 100 as text. The plot 600 shows that the instruction following process achieves improved performance (i.e. elevated average reward value) between episodes 10,000 and 50,000 when compared with that achieved by the baseline process. That is, at 10,000 episodes of training, the instruction following process achieved a higher average reward value 602a (i.e. between 0.05 and 0.1) when compared with an average reward 604a achieved by the baseline process (i.e. between negative 0.05 and negative 0.1). Furthermore, an average reward value 602b for the instruction following process at 50,000 episodes was between 0.15 and 0.2, whereas an average reward value 604b for the baseline process at the same number of episodes is between 0.05 and 0.1. This indicates that the agent 110, when trained according to the instruction following process, achieves improved performance during testing when compared with the agent 110 when trained according to the baseline process. Furthermore, the overall trend from 20,000 episodes onwards for the instruction following process is a positive trend, whereas the trend for the baseline process is not positive over the same period of episodes. This indicates that further training is beneficial for the agent 110 trained according to the instruction following process, whereas further training using the baseline process is not so beneficial.

FIG. 6B depicts a second plot 610 of data generated during experimentation with the reinforcement learning training processes described herein. The plot 610 comprises a first data point 612a indicating an average reward value of 0.057 for the baseline process, a second data point 612b indicating an average reward value of 0.159 for a first generation instruction following process, and a third data point 512c indicating an average reward value of 0.362 for a second generation instruction following process. Each data point was an average reward value across 50,000 training episodes. The first generation and second generation instruction following processes differed only in a number of search episodes, i.e. a number of episodes allowed during experiments for discovering, via exploration with the agent 110, possible observations of the environment 100. In experiments, both generations of the instruction following process achieved significantly higher average reward values than the baseline process over 50,000 training episodes.

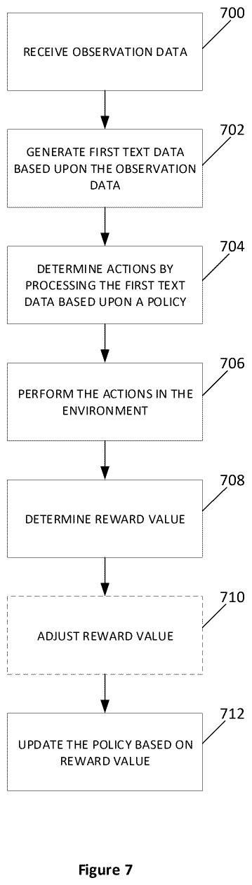

FIG. 7 is a flow diagram of a method for training an agent to perform actions in an environment using reinforcement learning.

At step 700, observation data indicating one or more observations of the environment in which the agent is configured to perform one or more actions is received. In some implementations, the observation data comprises image data, audio data, video data, numerical data, categorical data, time-series data, geospatial data, and/or sensor data. In some implementations, the observation data does not comprise text data.

At step 702, first text data indicating the one or more observations of the environment is generated based upon the observation data.

At step 704, one or more actions for the agent are determined by processing the first text data based upon a policy associated with the agent.

At step 706, the one or more actions determined for the agent are performed by the agent in the environment.

At step 708, in response to the agent performing the actions, a reward value associated with the one or more actions is determined based upon an objective function for the agent.

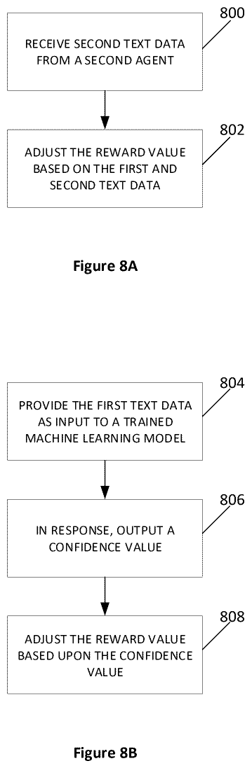

Optionally, at step 710, the reward value may be adjusted. For example, the reward value may be adjusted in accordance with the method described below with reference to FIGS. 8A and/or 8B.

At step 712, the policy of the agent is updated based upon the reward value.

FIG. 8A is a flow diagram of a first method for adjusting a reward value.

At step 800, second text data indicating one or more instructions for the agent is received from a second agent. In some implementations, the second agent is a human or machine learning model.

At step 802, the reward value is adjusted based upon the first text data and the second text data. In some implementations, adjusting the reward value based upon the first text data and the second text data comprises computing a similarity value based upon the first and second text data and adjusting the reward value based upon the similarity value. For example, the reward value may be adjusted by determining whether the similarity value exceeds a predetermined threshold. In yet other implementations, the method may further comprise validating whether the objective function for the agent is maximized or validating whether the agent has completed the one or more instructions for the agent. The method may further comprise adjusting the first text data based upon the validation. For example, the adjustment may comprise adjusting one or more values of the first text data such that the first text data converges or diverges to the second text data. The method may further comprise computing the similarity value, as previously described, based upon the adjusted first text data.

FIG. 8B is a flow diagram of a second method for adjusting a reward value.

At step 804, the first text data indicating the one or more observations is provided as input to a first trained machine learning model. In some implementations, the first trained machine learning model has been trained based upon a training dataset generated by receiving text data indicating one or more previous observations of the environment and ground truth text data indicating one or more previous instructions for the agent. The training dataset may be generated by validating, e.g. via the second agent, that the objective function for the agent is maximized or that the previous instructions for the agent have been completed (e.g. based upon the previous observations)

At step 806, in response to step 804, the first trained machine learning model outputs a confidence value indicating whether the agent has completed one or more previous instructions for the agent.

Ate step 808, the reward value as previously described may be adjusted based upon the confidence value. For example, the reward value may be increased in response to the confidence value exceeding a predetermined threshold.

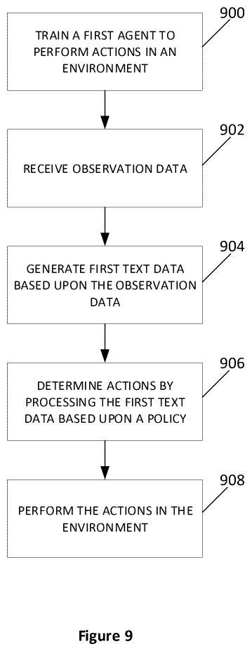

FIG. 9 is a flow diagram of a method for controlling an agent in an environment.

At step 900, the agent is trained to perform actions in the environment. The agent may be trained according to the methods described above, e.g. the method described with reference to FIGS. 7, 8A, and/or 8B.

At step 902, observation data indicating one or more observations of the environment in which the agent is configured to perform one or more actions.

At step 904, first text data indicating the one or more observations is generated based upon the observation data.

At step 906, one or more actions for the agent are determined by processing the first text data based upon a policy associated with the agent. The policy of the agent may be the same policy that was updated during trained, as described above.

At step 908, the one or more actions determined for the agent are performed by the agent in the environment.

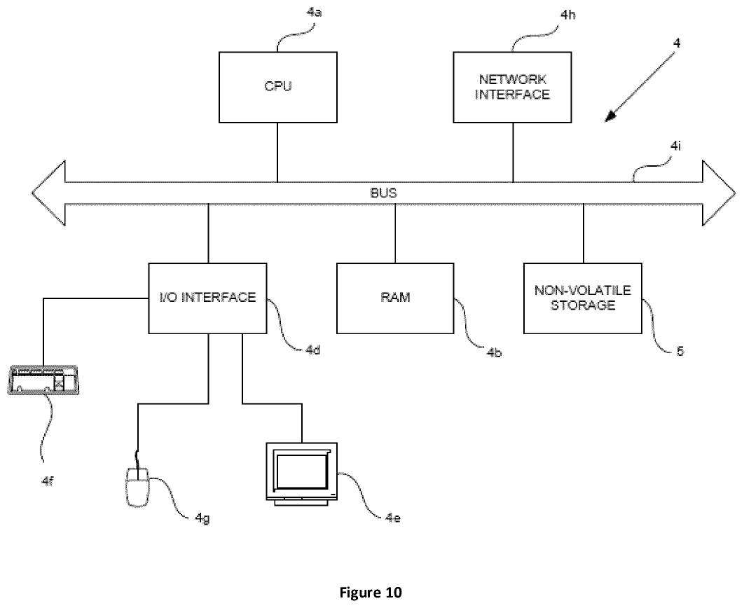

FIG. 10 schematically illustrates an exemplary arrangement of components which may provide a computing system 4 used to implement all or part of the systems described herein.

A processor, in this case in the form of a CPU 4a, configured to read and execute instructions stored in a volatile memory 4b which takes the form of a random access memory. It will be appreciated that the processor may take other forms, such as, for example, a GPU. The volatile memory 4b stores instructions for execution by the CPU 4a and data used by those instructions.

The computing system 4 comprises a storage device 5. It will be appreciated that the storage device 5 may be implemented in any way, such as for example, a hard disk drive, a solid state drive, etc. The storage device 5 may provide the means for storing data as described herein. The computing system 4 further comprises an I/O interface 4d to which are connected peripheral devices used in connection with the computing system. More particularly, a display 4e is configured so as to display output. Input devices are also connected to the I/O interface 4d. Such input devices include a keyboard 4f and a mouse 4g which allow user interaction with the computing system 4. A network interface 4h allows the computing system 4 to be connected to appropriate computer networks, such as the Internet 6, and so as to be able to send and receive from and to other computing devices. The CPU 4a, volatile memory 4b, the storage device 5, I/O interface 4d, and network interface 4h, are connected together by a bus 4i.

The techniques described above may be implemented in hardware, firmware, software, or any combination thereof. The techniques may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic storage media; optical storage media; flash memory devices; electrical, optical, acoustical or other forms of propagated signals (e.g. carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc. and in doing that may cause actuators or other devices to interact with the physical world.

It will be appreciated that any or all parts of the processes described herein may occur in the cloud (i.e. on one or more servers not depicted in the Figures) and/or on a local device (“client device”), e.g. a device physically in or near to the environment 100. While specific embodiments of the invention have been described above, it will be appreciated that the invention may be practiced otherwise than as described. The descriptions above are intended to be illustrative, not limiting. Thus it will be apparent to one skilled in the art that modifications may be made to the invention as described without departing from the spirit of the invention.

1. A computer-implemented method for training an agent to perform one or more actions in an environment using reinforcement learning, comprising:
receiving observation data indicating one or more observations of the environment in which the agent is configured to perform one or more actions;
generating, based upon the observation data, first text data indicating the one or more observations;
processing, based upon a policy associated with the agent, the first text data indicating the one or more observations to determine the one or more actions;
performing, by the agent, the determined one or more actions in the environment;
in response to the agent performing the determined one or more actions, determining, based upon an objective function for the agent, a reward value associated with the one or more actions; and
updating the policy of the agent based upon the reward value.

2. The computer-implemented method of claim 1, wherein the observation data comprises image data, audio data, video data, numerical data, categorical data, time-series data, geospatial data, and/or sensor data.

3. The computer-implemented method of claim 1, further comprising receiving, from a second agent, second text data indicating one or more instructions for the agent.

4. The computer-implemented method of claim 3, wherein the second agent is a human or a machine learning model, and wherein the policy is a machine learning model.

5. The computer-implemented method of claim 3, further comprising adjusting the reward value based upon the first text data and the second text data.

6. The computer-implemented method of claim 5, wherein adjusting the reward value based upon first text data and the second text data comprises:
computing a similarity value based upon first text data and the second text data; and
adjusting the reward value based upon the similarity value.

7. The computer-implemented method of claim 6, further comprising:
validating whether the objective function for the agent is maximized;
adjusting the first text data based upon the validation; and
wherein the similarity value is computed based upon the adjusted first text data.

8. The computer-implemented method of claim 1, further comprising adjusting the reward value by:
providing the first text data indicating the one or more observations as input to a first trained machine learning model to output a confidence value indicating whether the agent has completed one or more previous instructions for the agent; and
adjusting the reward value based upon the confidence value.

9. The computer-implemented method of claim 8, wherein the first trained machine learning model is trained based upon a training dataset generated by:
receiving third text data indicating one or more previous observations of the environment;
receiving, from a second agent, corresponding ground truth text data indicating the one or more previous instructions for the agent;
validating that the objective function for the agent is maximized; and
generating the training dataset based upon the third text data and ground truth data.

10. The computer-implemented method of claim 3, wherein the second text data is generated by the second agent based upon the first text data.

11. The computer-implemented method of claim 3, wherein generating the first text data is based upon the second text data.

12. The computer-implemented method of claim 1, wherein generating the first text data comprises:
determining, based upon a predetermined mapping of the observation data to text, first text indicating the one or more observations of the environment; and
processing the first text with a second trained machine learning model to output the first text data.

13. The computer-implemented method of claim 12, wherein the predetermined mapping corresponds to the environment.

14. A computer-implemented method for controlling an agent in an environment, comprising:
receiving observation data indicating one or more observations of the environment in which the agent is configured to perform one or more actions;
generating, based upon the observation data, first text data indicating the one or more observations;
processing, based upon a policy associated with the agent, the first text data indicating the one or more observations to determine the one or more actions;
performing, by the agent, the determined one or more actions in the environment; and
wherein the agent has been trained according to the method of claim 1.

15. A computing system comprising:
one or more processors;
one or more non-transitory computer-readable media storing computer-readable instructions configured to cause one or more processors to:
receive observation data indicating one or more observations of an environment in which an agent is configured to perform one or more actions;
generate, based upon the observation data, first text data indicating the one or more observations;
process, based upon a policy associated with the agent, the first text data indicating the one or more observations to determine the one or more actions;
perform, by the agent, the determined one or more actions in the environment;
in response to the agent performing the determined one or more actions, determine, based upon an objective function for the agent, a reward value associated with the one or more actions; and
update the policy of the agent based upon the reward value.

16. The computing system of claim 15, wherein the instructions are further configured to:
receive, from a second agent, second text data indicating one or more instructions for the agent; and
adjust the reward value based upon first text data and the second text data.

17. The computing system of claim 15, wherein the instructions are further configured to:
provide the first text data indicating the one or more observations as input to a first trained machine learning model to output a confidence value indicating whether the agent has completed one or more previous instructions for the agent; and
adjust the reward value based upon the confidence value.

18. One or more non-transitory computer-readable media storing computer-readable instructions configured to cause one or more computing devices to:
receive observation data indicating one or more observations of the environment in which an agent is configured to perform one or more actions;
generate, based upon the observation data, first text data indicating the one or more observations;
process, based upon a policy associated with the agent, the first text data indicating the one or more observations to determine the one or more actions;
perform, by the agent, the determined one or more actions in the environment;
in response to the agent performing the determined one or more actions, determine, based upon an objective function for the agent, a reward value associated with the one or more actions; and
update the policy of the agent based upon the reward value.

19. The one or more non-transitory computer-readable media of claim 18, wherein the instructions are further configured to:
receive, from a second agent, second text data indicating one or more instructions for the agent; and
adjust the reward value based upon first text data and the second text data.

20. The one or more non-transitory computer-readable media of claim 18, wherein the instructions are further configured to:
provide the first text data indicating the one or more observations as input to a first trained machine learning model to output a confidence value indicating whether the agent has completed one or more previous instructions for the agent; and
adjust the reward value based upon the confidence value.
